(19) United States
(12) Patent Application Publication
(10) Pub. No.: US 2008/0168250 A1
(43) Pub. Date: Jul. 10, 2008

(54) Unified memory apparatus for reconfigurable processor and method of using the unified memory apparatus

(75) Inventors: Gyu-sang choi, Seoul (KR); Jung-Keun Park, Seoul (KR); Chae-Seok Im, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/979,926

(22) Filed: Nov. 9, 2007

(30) Foreign Application Priority Data
Jan. 5, 2007 (KR) 10-2007-0001698

(51) Int. Cl. G06F 12/00

(52) U.S. Cl. 711/170; 711/E12.001

(57) ABSTRACT

A unified memory apparatus for a reconfigurable processor and a method of using the unified memory apparatus are provided. The unified memory apparatus includes: a first memory to store data; and a second memory to store configuration information used to reconfigure a system for a processor to perform a predetermined function, wherein the first memory and the second memory are physically unified in a unified memory. Thus, a memory space can be efficiently used according to data and size of configuration information.

### CROSS-REFERENCE TO RELATED APPLICATIONS

This application claims the benefit of Korean Patent Application No. 10-2007-0001698, filed on Jan. 5, 2007, in the Korean Intellectual Property Office, the disclosure of which is incorporated herein in its entirety by reference.

### BACKGROUND

1. Field

One or more embodiment disclosed hereafter relate to a memory apparatus, and more particularly, to a unified memory apparatus for a reconfigurable processor and a method of using the unified memory apparatus.

2. Description of the Related Art

As demands for multimedia information exchange through portable media devices, such as portable terminals and PDAs, surge, highly-efficient, low-power, and small-sized media systems should be designed.

A conventional multimedia application which requires high-efficiency and low-power is still embodied using an Application Specific Integrate Circuit (ASIC) because the multimedia application cannot be processed by a processor such as a Digital Signal Processor (DSP) having low-efficiency. However, due to the difficulties and high costs in designing an ASIC, a method of using a Reconfigurable Processor (RP), the intermediate form of the ASIC, has been proposed.

An RP includes a configuration memory which is not included in a General Purpose Processor (GPP). For example, the configuration memory is formed of a scratchpad memory. The configuration memory is a memory which only stores information about a system configuration, not a memory for existing data or instructions. In addition, apart from the configuration memory, the RP includes a scratchpad memory to store data as in a GPP.

However, when a storage space of the configuration memory or data memory is not sufficient, the RP should access a lower memory to obtain configuration information or data.

In this case, since a frequency of accessing a lower memory by the PR increases, a task efficiency is decreased.

### SUMMARY

Additional aspects and/or advantages will be set forth in part in the description which follows and, in part, will be apparent from the description, or may be learned by practice of the invention.

An aspect of the embodiment provides a unified memory apparatus in which memory structures that are separated in a reconfigurable processor are unified.

Another aspect of the embodiment also provides a method of using the unified memory apparatus according to an execution mode of a processor.

According to an aspect of the embodiment, there is provided a unified memory apparatus including: a first memory storing data; and a second memory storing configuration information required to reconfigure a system for a processor to perform a specific function, wherein the first memory and the second memory are physically unified in a unified memory.

According to another aspect of the embodiment, there is provided a method of using a unified memory in which a first memory to store data and a second memory to store configuration information used to reconfigure a system for a processor to perform a specific function are unified in a unified memory, the method including: determining an execution mode of the processor; and respectively allocating data and configuration information to the unified memory according to the determination result.

According to another aspect of the embodiment, there is provided a recordable medium having embodied thereon a computer system for executing the method described above.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram of a general memory structure in a General Purpose Processor (GPP);

FIG. 2 is a diagram of a general memory structure in a Reconfigurable Processor (RP);

FIG. 3 is a diagram of a unified memory apparatus in a Reconfigurable Processor (RP) according to an embodiment; and

FIG. 4 is a flowchart illustrating a method of using the unified memory apparatus illustrated in FIG. 3, according to an embodiment.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the embodiments by referring to the figures.

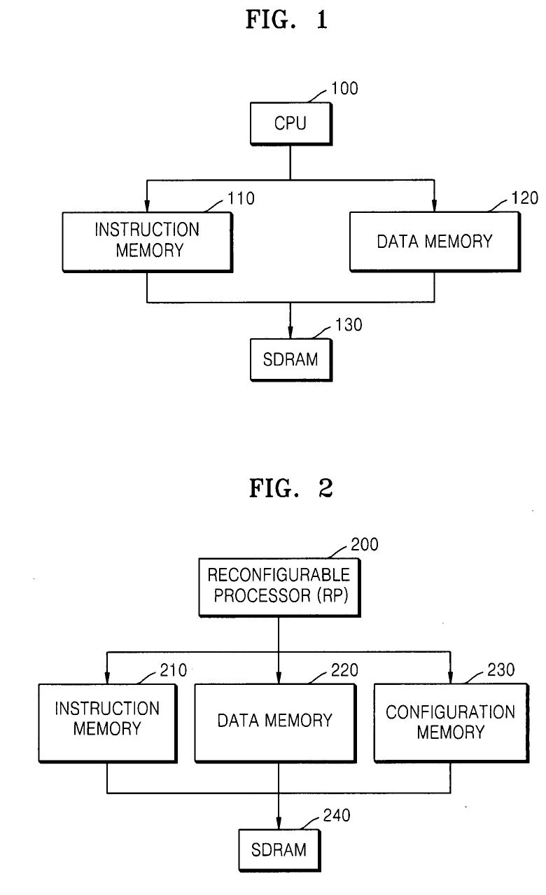

FIG. 1 is a diagram of a general memory structure in a General Purpose Processor (GPP).

Referring to FIG. 1, a Central Processing Unit (CPU) 100, an instruction memory 110, a data memory 120, and SDRAM 130 are illustrated.

The CPU 100 is mounted in a general embedded system. The instruction memory 110 stores instructions of the CPU 100. The instructions are transmitted to a computer processor embodied thereon a computer program. At the lowest level, each instruction is a series of 0s and 1s indicating a physical operation to be performed by a computer, a register specifier storing data for executing the instruction according to a form of the instruction, a location of data for executing the instruction, or a location in the memory for directly or indirectly referring to the data. The instruction memory 110 is generally located between the CPU 100 and the SDRAM 130 or a cache memory (not shown).

The data memory 120 stores a data. Similarly to the instruction memory 110, the data memory 120 is located between the CPU 100 and the SDRAM 130. The data memory 120 may be a cache memory or a scratchpad memory.

The scratchpad memory is an on-chip data memory and an address location thereof is separated from an off-chip memory. However, the scratchpad memory is connected to using the same address and data bus. Quick data access is possible in the case of the cache memory and scratchpad memory, however, relatively longer access time is required in the case of the off-chip memory.

A difference between the cache memory and the scratchpad memory is that the scratchpad memory guarantees the access time of one cycle, whereas the cache memory does not guarantee the access time due to a cache miss. Thus, data which is important to match the limited access time in a real-time system is stored in the scratchpad memory. In other words, unlike the cache memory, since an address stored once in the scratchpad memory is not released from the memory, the reuse rate of the scratchpad memory is not high like in a packet data in a network system, however, the scratchpad memory is used for data which greatly affect an efficiency of the system.

The SDRAM 130 may be any kind of DRAM in which a clock speed is synchronized with a processor so that number of instructions which can be performed by the processor in a given time can be increased. The SDRAM 130 is used as a general storage space for an embedded system according to an embodiment. In addition, the SDRAM 130 is located below the instruction memory 110 and the data memory 120 and functions as a lower memory in the entire memory structure.

Such memory structure is formed since the memory located near the CPU 100 has small storage capacity, is very fast and expensive, whereas the memory away from the CPU 100 has large storage capacity, is relatively slow and low-priced.

The access time for the cache memory or the scratchpad memory is faster by approximately 10 to 1000 times than the access time for the SDRAM 130. Thus, data or instructions are read from the cache memory or the scratchpad memory much faster, and thus the efficiency of the entire system can be increased.

Therefore, when the CPU 100 fetches the instructions from the instruction memory, the CPU 100 should firstly identify whether the instruction exists in the instruction memory 110. If the instruction exists in the instruction memory 110, the instruction is fetched from the instruction memory 110. If the instruction does not exist in the instruction memory 110, the instruction should be fetched from the SDRAM 130.

In addition, when the CPU 100 requires data, data can be fetched from the data memory 120, if the data exists in the data memory 120. If the data does not exist in the data memory 120, the data should be fetched from the SDRAM 130.

FIG. 2 is a diagram of a general memory structure in a Reconfigurable Processor (RP).

Referring to FIG. 2, a reconfigurable processor 200, an instruction memory 210, a data memory 220, a configuration memory 230, and a SDRAM 240 are illustrated.

The reconfigurable processor 200 is a microprocessor having an erasable hardware which can be rewired dynamically. In other words, the reconfigurable processor 200 is not a conventional CPU, but a processor based on reconfigurable logic. Such a processor efficiently interfaces a programming task which is required by a specific software in a predetermined period of time. The reconfigurable processor itself can convert a video chip into a central processing unit. For example, the reconfigurable processor can rapidly convert into a graphic chip which is optimized to operate an application.

Unlike the CPU 100, the reconfigurable processor 200 has the configuration memory 230 to store configuration information. The configuration memory 230 may be, for example, a scratchpad memory. The configuration information is information to reconfigure a system dynamically.

The configuration memory 230 is not a conventional memory for storing data or instructions, but a memory only storing information to configure a system. In addition, apart from the configuration memory 230, the reconfigurable processor 200 has the data memory 220 like a GPP.

The memory structure illustrated in FIG. 2 includes the separate configuration memory 230 together with the instruction memory 210 and the data memory 220. Such configuration information is linked with software and resides on the configuration memory 230. A memory structure, an initial address, and a data size of the configuration memory 230 are located in an initial address of the configuration memory 230 as header information. When the reconfigurable processor 200 starts reconfiguring, the header information is fetched from the configuration memory 230.

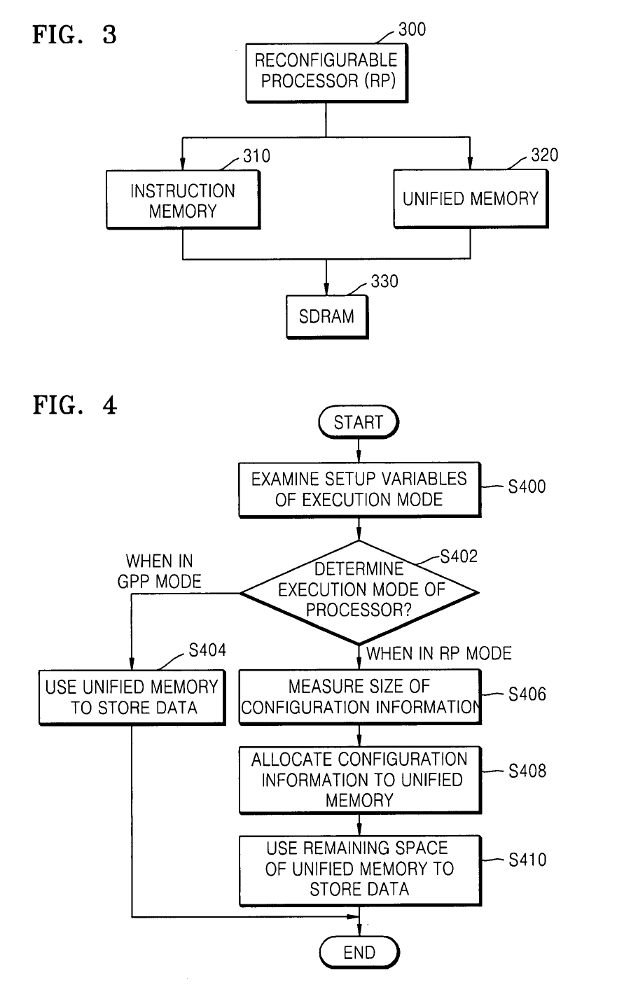

FIG. 3 is a diagram of a unified memory apparatus in a Reconfigurable Processor (RP) according to an embodiment.

Referring to FIG. 3, a reconfigurable processor 300, an instruction memory 310, a unified memory 320, and a SDRAM 330 are illustrated.

The difference between FIG. 2 and FIG. 3 is that the unified memory 320 in FIG. 3 includes a data memory and a configuration memory that are unified, according to an embodiment.

The unified memory 320 physically unifies a data memory and a configuration memory. A method of accessing the unified memory 320 in the reconfigurable processor 300 will be described later with reference to FIG. 4 according to an embodiment.

The unified memory 320 may use a scratchpad memory which guarantees the access time of one cycle.

Since the unified memory 320 is used as a data memory and a configuration memory in the reconfigurable processor 200, a memory with a larger storage capacity than that of conventional memories can be used. Therefore, the frequency on the lower level memory, for example, the frequency of accessing the SDRAM, can be decreased, thereby increasing the overall system performance.

For example, if the data memory has a capacity of 100 Kbytes and the configuration memory has a capacity of 50 Kbytes in the reconfigurable processor 200, each memory should be used separately. Therefore, if the data size of the task performed in a RP mode in the reconfigurable processor is 150 Kbytes, data of 100 Kbytes is located in the data memory (that is, the scratchpad memory), however, the remained data of 50 Kbytes cannot be located in the data memory. Thus, the remained data of 50 Kbytes should be located in the lower level memory, that is, the SDRAM. Then, the access to the memory of 50 Kbytes uses more time than that to the scratchpad memory, which negatively affects a performance of the task.

On the other side, the entire data of 150 Kbytes can be allocated to the unified memory 320 according to an embodiment and thus access to the slow lower level memory, that is, the SDRAM 330, can be prevented. Thus, a performance of the task increases.

In addition, even when the reconfigurable processor 300 is operated in a GPP mode, if the capacity of data required by the task is 120 Kbytes, data of 20 Kbytes should be located in a lower level memory in the memory structure of FIG. 2. However, according to an embodiment, the entire data of 120 Kbytes can be located in the unified memory 320. Therefore, the frequency of access to the lower level memory to read or write data can be reduced.

FIG. 4 is a flowchart illustrating a method of using the unified memory apparatus illustrated in FIG. 3, according to an embodiment.

The reconfigurable processor 300 is generally operated in two modes. First, the reconfigurable processor 300 is operates as a GPP. Such execution mode is defined as a “GPP mode”.

Second, when a system needs to be changed to correspond to other specific purpose, the reconfigurable processor 300 is operated as an RP. Such execution mode is defined as an “RP mode”.

When in the GPP mode, the unified memory 320 according to an embodiment is used as a data memory to store data and is not used as a configuration memory. On the contrary, when in the RP mode, the unified memory 320 is used as a memory to store data and configuration information.

In operation 400, setup variables of an execution mode are examined in a specific program. In operation 402, an execution mode of the processor is determined. In other words, it is determined whether the processor is in the RP mode of the GPP mode.

Whether the processor is in the RP mode or GPP mode is determined according to the system variables. For example, a variable setting an execution mode “exec_mode” should exist in the system. Whether the system is operated with the RP mode or the GPP mode is determined according to the value.

Therefore, when “exec_mode” is set to “RP” in a specific program, the processor is in the RP mode, and when the “exec_mode” is set to “GPP” in a specific program, the processor is in the GPP mode. When a user prepares and compiles a program, “exec_mode” is automatically set up. That is, which part of the program is operated in the RP mode or GPP mode are determined during compiling.

According to the method of determining the operating mode, when an execution mode of the processor is in the GPP mode, the unified memory 320 is used to store data in operation 404. That is, the entire space of the unified memory 320 can be used only to store data.

On the other hands, when an execution mode of the processor is in the RP mode, a size of configuration information required to reconfigure a system is measured in operation 406. Then, in operation 408, configuration information is allocated on the unified memory 320 to correspond to the measured size of configuration information. Various allocation methods can be used to allocate the space of the unified memory 320. For example, configuration information is allocated from a bottom of one side of the unified memory 320 and data is allocated from the top of the opposite side of the unified memory 320. More specifically, a variable “end_of_configuration_memory” exists in the unified memory 320 so that when configuration information is firstly allocated in the space of the configuration memory of the unified memory 320, a size of the configuration information can be secured and the value is stored in “end_of_configuration_memory”. Therefore, when a user allocates memory used to operate a general program, memory cannot be allocated beyond the size of the configuration memory.

After configuration information is allocated in the unified memory 320, a remained space of the unified memory 320 is used to store data in operation 410. In addition, when the processor is operated in the GPP mode, information for system reconfiguration is not needed and thus the entire space of the unified memory 320 can be used to store data. Accordingly, since a memory capacity to store data increases, the lower memory characteristic, that is, a frequency of access by the SDRAM, can be reduced and a performance of a task can be improved.

When the processor is operated in the RP mode, configuration information is firstly allocated to the unified memory 320 and a remained space of the unified memory 320 is used to store data. Accordingly, when a size of the configuration information is larger than that of the configuration memory, that is, when an amount of information required for system reconfiguration is larger than a predetermined configuration memory, configuration information does not need to be fetched from the SDRAM. In addition, when an amount of configuration information is smaller than a size of the configuration memory, a remained space can be used for data and thus a space for data is increased. Therefore, a performance of a task can be improved.

An aspect of the embodiment, a first memory to store data and a second memory to store configuration information required to reconfigure a system to perform a specific function are described. The first and second memories are physically unified in one unified memory and thus a memory space can be efficiently used according to data and a size of configuration information.

In addition, when the processor is operated in a RP mode, the unified memory is used for configuration information and when the processor is operated in a GPP mode, the unified memory is used for data, respectively. Thus, in each mode, more memory space can be used so as to improve a performance thereof.

Moreover, the frequency of accessing the lower memory by the processor to fetch data or configuration information is reduced and thus a performance of a task can be improved.

One or more embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A unified memory apparatus comprising:
a first memory to store data; and
a second memory to store configuration information used to reconfigure a system for a processor to perform a predetermined function,
wherein the first memory and the second memory are physically unified in a unified memory.

2. The unified memory apparatus of claim 1, the unified memory is used exclusively to store data and configuration information.

3. The unified memory apparatus of claim 1, wherein the first memory and the second memory are scratchpad memories.

4. The unified memory apparatus of claim 1, wherein the processor is a reconfigurable processor.

5. A method of using a unified memory in which a first memory to store data and a second memory to store configuration information used to reconfigure a system for a processor to perform a specific function are unified in a unified memory, the method comprising:
determining an execution mode of the processor; and
respectively allocating data and configuration information to the unified memory according to the determination result.

6. The method of claim 5, wherein the unified memory is used exclusively for storing data and configuration information.

7. The method of claim 5, further comprising when the execution mode is a reconfigurable processor mode in the determining, determining a size of configuration information required to reconfigure a system for the processor to perform a specific function

8. The method of claim 5, wherein the allocating data and configuration information data and configuration information are allocated to the unified memory to correspond to the size of the configuration information.

9. The method of claim 7, wherein the allocating data and configuring further comprises allocating an area to the remained unified memory after the configuration information is allocated to the area of the unified memory to store data.

10. The method of claim 5, further comprising examining system setup variables before the determining, wherein in the determining an execution mode of the processor is determined according to the examination result.

11. The method of claim 5, wherein in the allocating data and configuration information, when the execution mode is a General Purpose Processor mode, only data is allocated to the unified memory.

12. The method of claim 5, wherein the first memory and the second memory are scratchpad memories.

13. The method of claim 5, wherein the processor is a reconfigurable processor.

14. A recordable medium having embodied thereon a computer system for executing the method of claim 5.

15. A reconfigurable processor apparatus, comprising:
a reconfigurable processor;
an instruction memory; and
a unified memory.

16. The reconfigurable processor apparatus of claim 15, wherein the unified memory to store configuration information.
